(19) United States
(12) Patent Application Publication
(10) Pub. No.: US 2017/0289407 A1
(43) Pub. Date: Oct. 5, 2017

(54) IMAGE-FORMING DEVICE THAT CONVERTS COLOR OF INPUT IMAGE AND GENERATES OUTPUT IMAGE IN WHICH SPECIFIC COLOR IS ENHANCED, COMPUTER-READABLE RECORDING MEDIUM THAT STORES COLOR-CONVERSION PROGRAM, AND COLOR-CONVERSION METHOD

(71) Applicant: KYOCERA Document Solutions Inc., Osaka (JP)

(72) Inventor: Yuka MIYANAGA, Osaka (JP)

(73) Assignee: KYOCERA Document Solutions Inc., Osaka (JP)

(21) Appl. No.: 15/476,383

(22) Filed: Mar. 31, 2017

(30) Foreign Application Priority Data
Mar. 31, 2016 (JP) 2016-072674

(51) Int. Cl. H04N 1/60; H04N 1/00; H04N 1/21

(52) U.S. Cl. CPC H04N 1/6008; H04N 1/21; H04N 1/00408; H04N 2201/0094

(57) ABSTRACT

An image-forming device includes a Central Processing Unit (CPU) and a storage device, wherein the storage device stores a color-conversion program, and the CPU functions as a centroid acquisition unit, a color-conversion-information generation unit, and an output-image generation unit. The centroid acquisition unit acquires a centroid of a cluster of approximate colors in an input image. The color-conversion-information generation unit generates color-conversion information for converting the input image to an output image. The output-image generation unit converts color in the input image, and generates the output image. The color-conversion information is information for moving a color in the input image according to movement of the centroid when moving the centroid to a representative color in a specific range.

### INCORPORATION BY REFERENCE

This application is based on and claims the benefit of priority from Japanese Patent Application No. 2016-072674 filed on Mar. 31, 2016, the contents of which are hereby incorporated by reference.

### BACKGROUND

The present disclosure relates to an image-forming device that generates an output image by converting colors of an input image, a non-transitory computer-readable recording medium that stores a color-conversion program, and a color-conversion method.

Typically, an image-forming device is known that moves colors outside a color gamut to within the color gamut when generating an output image by converting colors of an input image.

### SUMMARY

The image-forming device of the present disclosure includes a Central Processing Unit (CPU) and storage device that stores a color-conversion program, wherein the CPU, by executing the color-conversion program, functions as a centroid acquisition unit, a color-conversion-information generation unit, and an output-image generation unit. The centroid acquisition unit acquires a centroid of a cluster, which is a collection of approximate colors in an input image. The color-conversion-information generation unit generates color-conversion information for converting the input image to an output image. The output-image generation unit converts color in the input image by using the color-conversion information that is generated by the color-conversion-information generation unit, and generates the output image. In the case where the centroid that is acquired by the centroid acquisition unit is included in a specific range in color space, the color-conversion information is information for moving a color in the input image according to movement of the centroid when moving the centroid to a representative color in the specific range.

The present disclosure discloses a non-transitory computer-readable recording medium for storing a color-conversion program. The color-conversion program causes a Central Processing Unit (CPU) of an image-forming device to function as: a centroid acquisition unit that acquires a centroid of a cluster, which is a collection of approximate colors in an input image; a color-conversion-information generation unit that generates color-conversion information for converting the input image to an output image; and an output-image generation unit that converts the color in the input image by using the color-conversion information that is generated by the color-conversion-information generation unit and generate the output image. In the case where the centroid that is acquired by the centroid acquisition unit is included in a specific range in color space, the color-conversion information is information for moving a color in the input image according to movement of the centroid when moving the centroid to a representative color in the specific range.

The present disclosure discloses a color-conversion method performed by an image-forming device that includes a Central Processing Unit (CPU) and storage device. The storage device stores a color-conversion program, and the method, by executing the color-conversion program by the CPU, including: acquiring a centroid of a cluster, which is a collection of approximate colors in an input image; generating color-conversion information for converting the input image to an output image; and converting the color in the input image by using the color-conversion information that is generated and generates the output image. In the case where the centroid that is acquired is included in a specific range in color space, the color-conversion information is information for moving a color in the input image according to movement of the centroid when moving the centroid to a representative color in the specific range.

### BRIEF DESCRIPTION OF THE DRAWINGS

FIG. 1 is a block diagram of an MFP of an embodiment of the present disclosure.

FIG. 2 is a flowchart of the operation of the MFP illustrated in FIG. 1 when executing printing based on printing data that are inputted externally.

FIG. 3 is a flowchart of the input value acquisition process illustrated in FIG. 2.

FIG. 4 is a flowchart of the characteristic color acquisition process illustrated in FIG. 2.

FIG. 5 is an example of a graph that illustrates a data string that is generated in the process illustrated in FIG. 4.

FIG. 6 is a flowchart of the centroid initial value calculation process illustrated in FIG. 4.

FIG. 7 is an example of a graph that illustrates a data string that is sorted in the process illustrated in FIG. 6.

FIG. 8 is a flowchart of the registration flag update process illustrated in FIG. 6.

FIG. 9 illustrates the hue angle that is calculated in the process illustrated in FIG. 8.

FIG. 10 illustrates an example of an angular range for which special correction is performed in the process illustrated in FIG. 8.

FIG. 11 illustrates judgment criteria used in the process illustrated in FIG. 8.

FIG. 12 is a flowchart of the cluster analysis process illustrated in FIG. 4.

FIG. 13 is a flowchart of the affiliate cluster determining process illustrated in FIG. 12.

FIG. 14 is a flowchart of the cluster centroid update process illustrated in FIG. 12.

FIG. 15 is a flowchart of the color adjustment process illustrated in FIG. 2.

FIG. 16A illustrates a hue plane that includes the range of a memory color for a plant leaf that is used in the process illustrated in FIG. 15.

FIG. 16B illustrates the angle range of the range illustrated in FIG. 16A.

FIG. 17 illustrates the direction of movement of the cluster centroid on a hue plane that includes a representative value of the memory color of the plant leaf illustrated in FIG. 16A and FIG. 16B.

FIG. 18 illustrates the direction of movement of a color in the hue plane that includes a representative value of the memory color of the plant leaf illustrated in FIG. 16A and FIG. 16B.

FIG. 19 illustrates the amount of movement of a color in a hue plane that includes a representative value of the memory color of the plant leaf illustrated in FIG. 16A and FIG. 16B.

FIG. 20 illustrates the range of movement in 3-dimensional space around the representative value of the memory color of the plant leaf illustrated in FIG. 16A and FIG. 16B.

FIG. 21A illustrates a hue plane that includes a range of memory color of sky used in the process illustrated in FIG. 15.

FIG. 21B illustrates the angle range of the range illustrated in FIG. 21A.

FIG. 22 illustrates the direction of movement of the cluster centroid on a hue plane that includes a representative value of the memory color of the sky illustrated in FIG. 21A and FIG. 21B.

FIG. 23A illustrates a hue plane that includes a range of memory color of human skin used in the process illustrated in FIG. 15.

FIG. 23B illustrates the angle range of the range illustrated in FIG. 23A.

FIG. 24 illustrates the direction of movement of the cluster centroid on a hue plane that includes a representative value of the memory color of the human skin illustrated in FIG. 23A and FIG. 23B.

### DETAILED DESCRIPTION

In the following, an embodiment of the present disclosure will be explained using the drawings.

First, the configuration of an MFP (Multifunction Peripheral) will be explained as an image-forming device of an embodiment of the present disclosure.

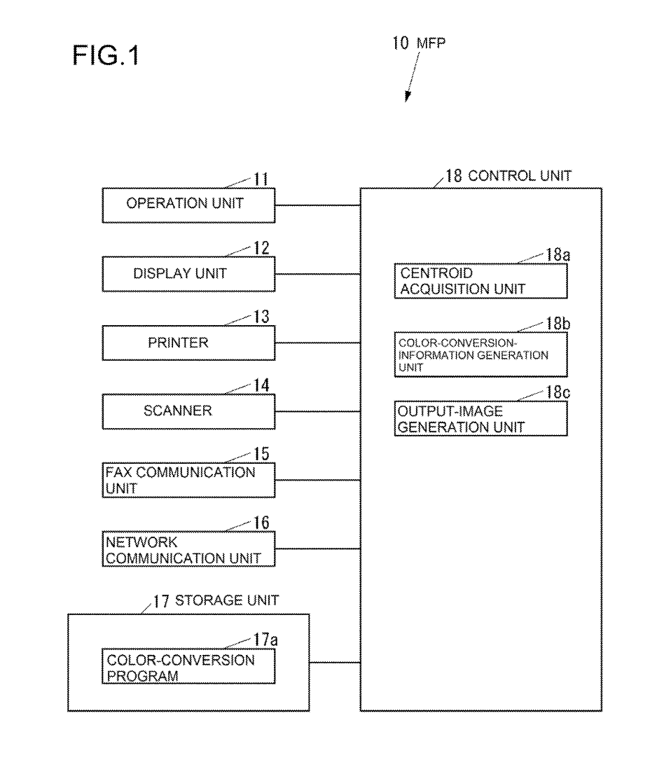

FIG. 1 is a block diagram of the MFP 10 of this embodiment.

As illustrated in FIG. 1, the MFP 10 includes an operation unit 11, a display unit 12 , a printer 13 , a scanner 14 , a FAX communication unit 15, a network communication unit 16, a storage unit 17, and a control unit 18. The operation unit 11 is an input device such as button and the like by which various operations are inputted. The display unit 12 is a display device such as a LCD (Liquid Crystal Display) and the like that displays various information. The printer 13 is a printing device that executes printing on a recording medium such as paper. The scanner 14 is a reading device that reads images from a document. The FAX communication unit 15 is a FAX device that performs FAX communication with an external facsimile device via communication lines such as public telephone lines. The network communication unit 16 is a network communication device that performs communication with an external device via a network such as a LAN (Local Area Network), Internet and the like. The storage unit 17 is a non-volatile storage device such a semiconductor memory, HDD (Hard Disk Drive) and the like that store various kinds of information. The control unit 18 performs overall control of the MFP 10.

The storage unit 17 is able to store a color conversion program 17a that converts colors. The color conversion program 17a may be installed on the MFP 10 during the manufacturing state of the MFP 10. The color conversion program 17a may also be additionally installed on the MFP 10 from a storage medium such as an SD card, USB (Universal Serial Bus) memory and the like. The color conversion program 17a may also be additionally installed on the MFP 10 from a network.

The control unit 18 includes, for example, a CPU (Central Processing Unit), ROM (Read Only Memory) and RAM (Random Access Memory) and the like. The ROM stores programs and various kinds of data. The RAM is used as a work area for the CPU. The CPU executes a program that is stored in the storage unit 17 or the ROM.

The control unit 18, by executing the color conversion program 17a that is stored in the storage unit 17, functions as a centroid acquisition unit 18a, color-conversion-information generation unit 18b, and output-image generation unit 18c. The centroid acquisition unit 18a acquires the centroid of a cluster (hereafter, referred to as a “cluster centroid”), being a collection of approximate colors in an image that is included in printing data that is inputted externally (hereafter, referred to as an “input image”). The color-conversion-information generation unit 18b generates a color-conversion list as color-conversion information for converting an input image to an output image. The output-image generation unit 18c generates an output image by converting the colors in an input image by using the color-conversion list that is generated by the color-conversion-information generation unit 18b.

Next, the operation of the MFP 10 will be explained.

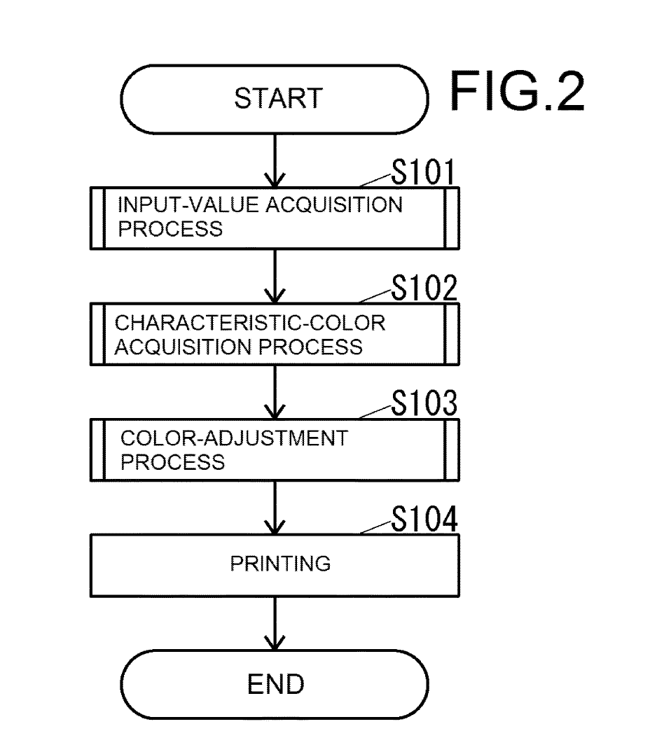

FIG. 2 is a flowchart of the operation of the MFP 10 when executing printing based on printing data that is inputted externally.

As illustrated in FIG. 2, the centroid acquisition unit 18a executes an input-value acquisition process for acquiring RGB values (hereafter, referred to as “input values”) in an input image as an image that is included in printing data (S101).

Next, the centroid acquisition unit 18a, based on the input values that are acquired in S101, executes a characteristic-color acquisition process for acquiring a representative color of the dominant color in the input image, or in other words, a cluster centroid as the characteristic color of the input image (S102).

The color-conversion-information generation unit 18b and the output-image generation unit 18c then execute a color-adjustment process that generates an output image by adjusting the color of the input image according to the representative color that is found in S102 (S103).

Next, by way of the printer 13, the output-image generation unit 18cprints the output image that is generated in S103 (S104), and the operation illustrated in FIG. 2 ends.

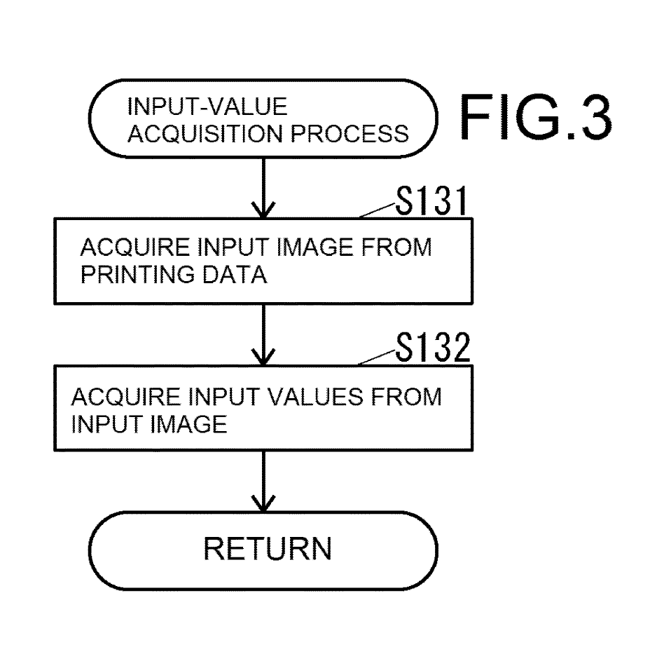

FIG. 3 is a flowchart of the input-value acquisition process of S101.

As illustrated in FIG. 3, the centroid acquisition unit 18a acquires an input image, which is a color image, from the printing data, or in other words, acquires the portion that expresses color (S131).

Next, the centroid acquisition unit 18a acquires RGB values for each of the pixels in the input image that is acquired in S131 (S132), and the process illustrated in FIG. 3 ends.

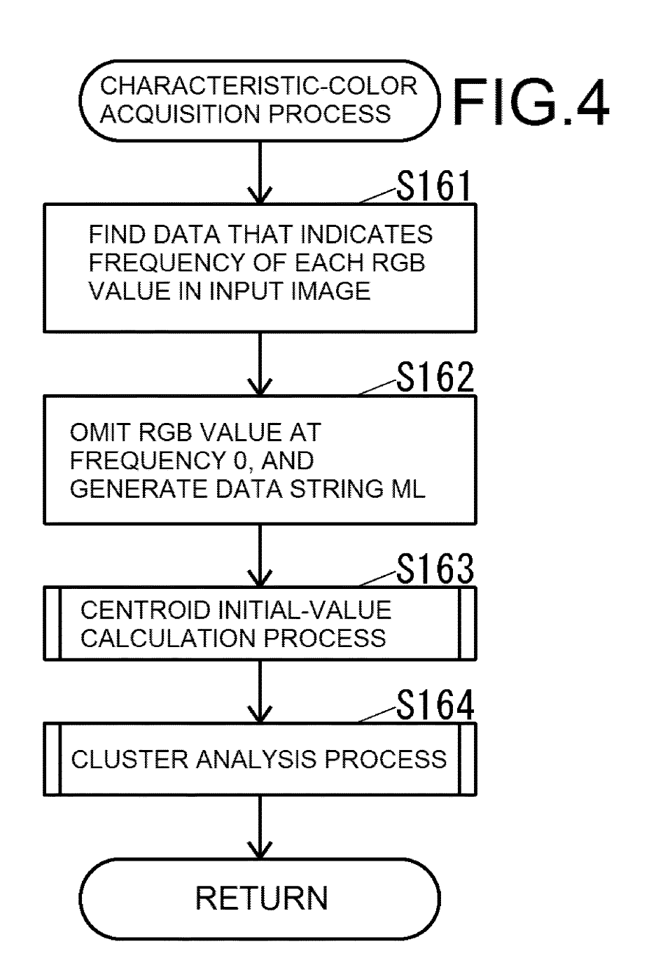

FIG. 4 is a flowchart of the characteristic-color acquisition process of S102.

As illustrated in FIG. 4, the centroid acquisition unit 18a, based on the input values that are acquired for each of the pixels in S132, finds data that indicates a frequency for each RGB value in the input image (S161). By the processing in S161, information for identifying each pixel is deleted from the input values that are acquired for each pixel in S132, so that there is only color information. Therefore, it is possible to reduce the amount of data that is handled in the continuing processes.

Next, by omitting the RGB value at a frequency of 0 from the data that is found in 161, the centroid acquisition unit 18a generates a data string ML that illustrates the relationship between the RGB values in the input image and the frequency (S162).

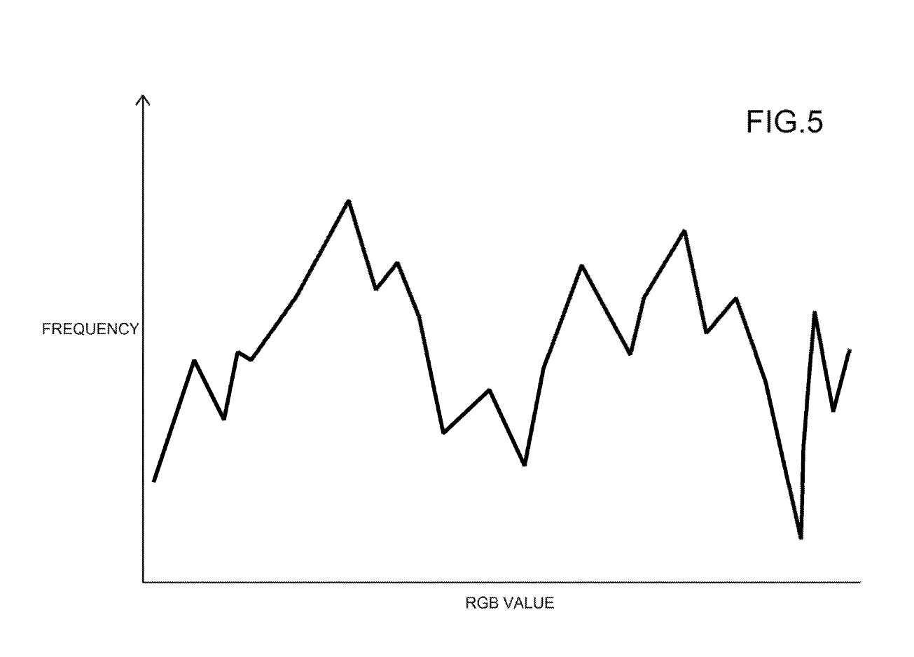

FIG. 5 is an example of a graph that illustrates a data string ML that is generated in S162.

As illustrated in FIG. 5, in the data string ML that is generated in S162 RGB values are arranged according to specific rules unrelated to the frequency.

As illustrated in FIG. 4, after the process in S162, the centroid acquisition unit 18a, based on the data string ML that is generated in S162, executes a centroid-initial-value calculation process that calculates an initial value for the cluster centroid (S163).

Next, the centroid acquisition unit 18a uses the initial value that is calculated in S163, and executes a cluster analysis process that finds a cluster centroid (S164), and the processing illustrated in FIG. 4 ends.

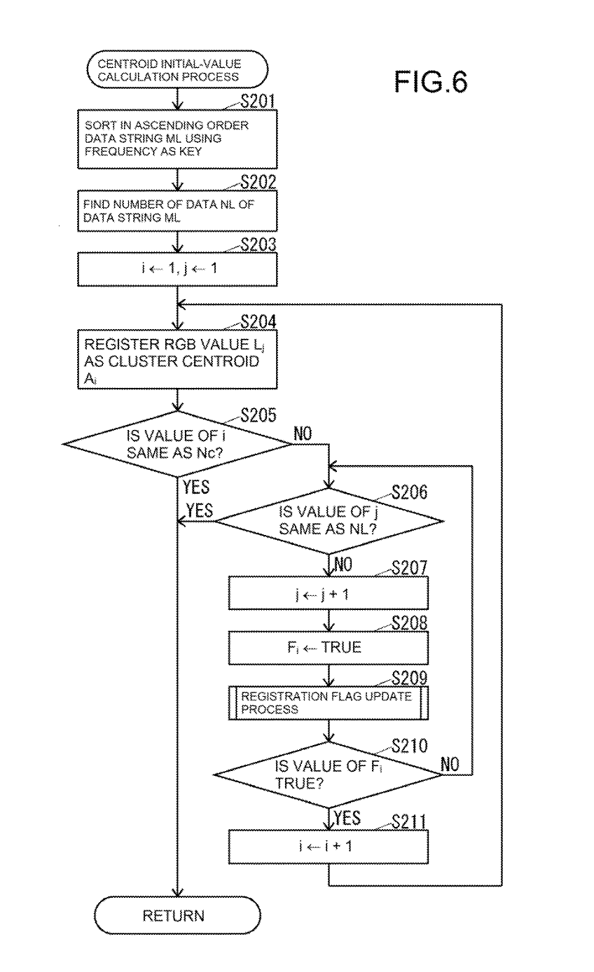

FIG. 6 is a flowchart of the centroid initial-value calculation process of S163.

As illustrated in FIG. 6, the centroid acquisition unit 18asorts in descending order the data string ML that is generated in S162 using the frequency as a key (S201).

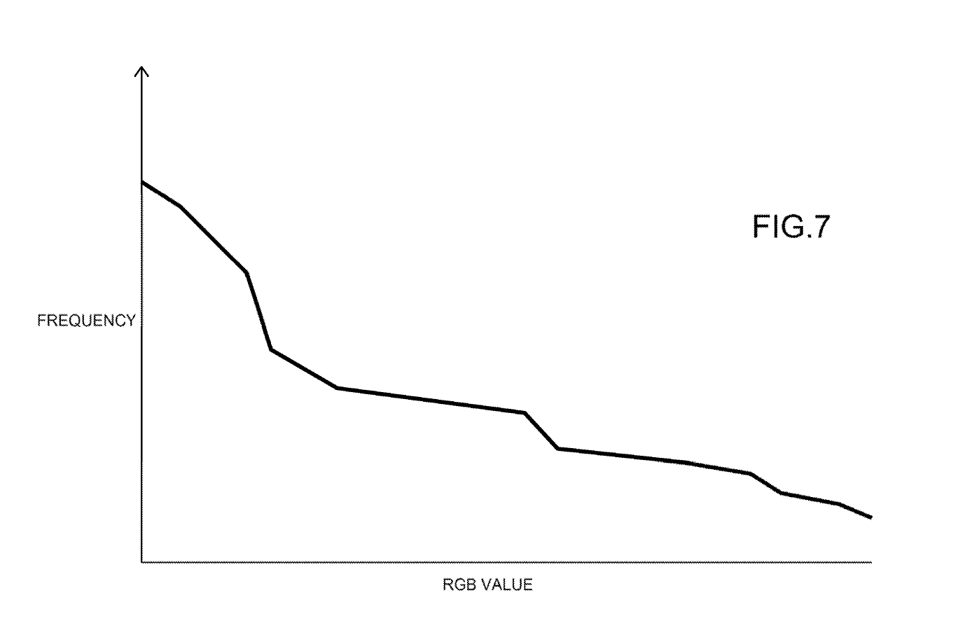

FIG. 7 is an example of a graph that illustrates the data string ML that is sorted in S201.

The data string ML illustrated in FIG. 7 is the result of sorting the data string illustrated in FIG. 5 by the processing of S201. As illustrated in FIG. 7, the data string ML that is sorted in S201 is RGB values that are arranged in an order from the RGB having the largest frequency toward the RGB value having the smallest frequency.

As illustrated in FIG. 6, the centroid acquisition unit 18a finds the number of data NL in the data string ML, or in other words, finds the number of types of RGB values in the data string ML after the processing in S201 (S202).

In the following, each RGB value of the data string ML that is sorted in S201 is expressed as an RGB value Lⱼ using the variable j. Here, the variable j can be an integer 1 or greater. For example, the first RGB value of the data string ML that is sorted in S201, or in other words, the RGB value having the largest frequency, is RGB Value L₁. Moreover, the last RGB value of the data string ML that is sorted in S201, or in other words, the RGB value have the smallest frequency is the RGB value L_{NL}.

Moreover, each cluster centroid that is registered is represented as a cluster centroid Aᵢ using the variable i. Here, the variable i can be an integer that is 1 or greater.

Furthermore, a registration flag that is used in determining whether or not to register an RGB value Lⱼ as a cluster centroid Aᵢ is expressed as registration flag Fᵢ that uses the variable i. The registration flag Fᵢ can be one of the values True and False. The state in which the registration flag Fᵢ is True indicates a state in which the target RGB value Lⱼ is a candidate as a cluster centroid. However, the state in which the registration flag Fᵢ is False indicates a state in which the target RGB value Lⱼ is not a candidate as a cluster centroid.

The centroid acquisition unit 18a, after the processing of S202, substitutes 1 for the variable i and variable j (S203).

Next, the centroid acquisition unit 18a registers the RGB value Lⱼ as a cluster centroid Aᵢ (S204). In other words, the centroid acquisition unit 18a registers the RGB value in the data string ML having the highest frequency as the first cluster centroid.

After the processing in S204, the centroid acquisition unit 18a determines whether or not the variable i, or in other words, the number of cluster centroid registrations has reached a fixed number Nc (S205).

When it is determined in S205 that the number of cluster centroid registrations has not reached the fixed number Nc, the centroid acquisition unit 18a determines whether or not the variable j is the number of data NL that is found in S202 (S206).

When the value of variable j is not the number of data NL, or in other words, when it is determined in S206 that processing up to the last RGB value of the data string ML that is sorted in S201 has not finished, the centroid acquisition unit 18aadds 1 to the variable j (S207).

Next, the centroid acquisition unit 18a initializes the registration flag Fᵢ to True (S208).

After the processing in S208, the centroid acquisition unit 18a executes a registration flag update process for updating the registration flag Fᵢ based on the positional relationship of the RGB value Lⱼ and the registered cluster centroid in the color space (S209).

Next, the centroid acquisition unit 18a determines whether or not the registration flag Fᵢ is True (S210).

When it is determined in S210 that the registration flag Fᵢ is True, the centroid acquisition unit 18a adds 1 to the variable i (S211), and executes the processing in S204. In other words, the centroid acquisition unit 18aregisters the RGB value Lⱼ as an additional cluster centroid.

When it is determined in S210 that the registration flag Fᵢ is not True, the centroid acquisition unit 18a executes the processing of S206.

The centroid acquisition unit 18a determines in S205 whether the number of cluster centroid registrations has reached the fixed number Nc, or the value of variable j is the number of data NL. In other words, when it is determined in S206 that processing up to the last RGB value of the data string ML that is sorted in S201 is finished, the processing illustrated in FIG. 6 ends. In other words, when the number of cluster centroid registrations has reached the fixed number Nc, or processing up to the last RGB value of the data string ML has finished, cluster centroid registration ends. Color reproduction having sufficient precision is possible with a certain number of cluster centroids, for example 10, so the fixed number Nc is set as the upper limit for the number of cluster centroid registrations.

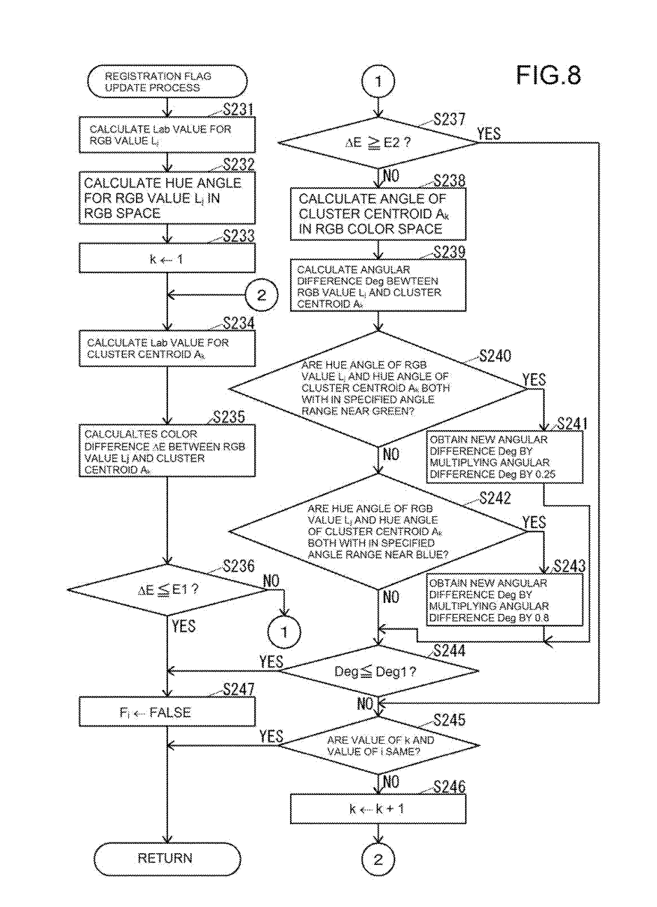

FIG. 8 is a flowchart of the registration flag update process of S209.

As illustrated in FIG. 8, the centroid acquisition unit 18a calculates a Lab value that corresponds to the RGB value Lⱼ (S231). Here, when a profile is included in the input image, the centroid acquisition unit 18a calculates a Lab value that corresponds to the RGB value Lⱼ according to the profile that is included in the input image. However, when a profile is not included in the input image, the centroid acquisition unit 18a calculates a Lab value that corresponds to the RGB value Lⱼ by converting the RGB value Lⱼ to a RGB (standard RGB) value and calculating the Lab value for this SRGB value.

After the processing of S231, the centroid acquisition unit 18a calculates the hue angle for the RGB value Lⱼ in RGB color space (S232). Here, the centroid acquisition unit 18a calculates the hue angle of the RGB value Lⱼ as an angle around the center axis as a straight line that passes through white and black in RGB color space.

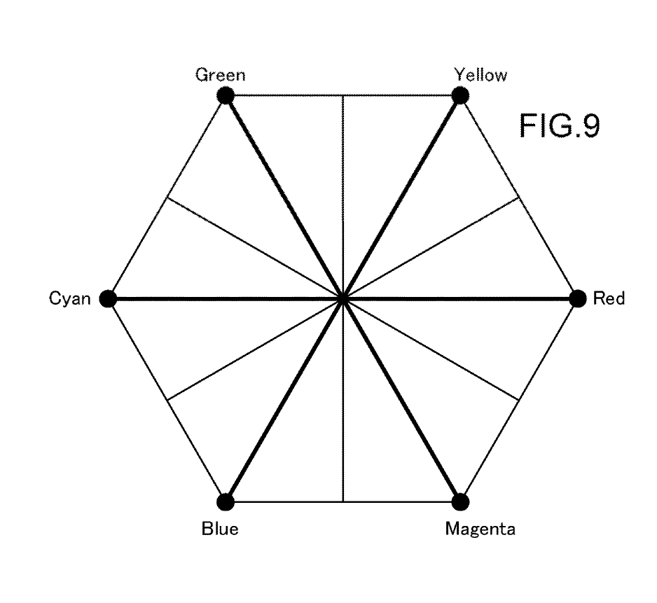

FIG. 9 illustrates the hue angle calculated in S232.

FIG. 9 is for the case in which the RGB color space is observed in the extending direction of a straight line that passes through white and black. The hue angle for Red is taken to be 0°, and the hue angles for Yellow, Green, Cyan, Blue, and Magenta are taken to be 60°, 120°, 180°, 240° (−120°) , and 300° (−60°), respectively.

As illustrated in FIG. 8, after the processing in S232, the centroid acquisition unit 18a substitutes 1 for variable k (S233). Here, variable k can be an integer 1 or more.

After the processing in S233, the centroid acquisition unit 18a calculates a Lab value that corresponds to the cluster centroid Aₖ as in the processing in S231 (S234).

Next, the centroid acquisition unit 18a calculates the color difference ΔE between the RGB value Lⱼ and the cluster centroid Aₖ based on the Lab value calculated in S234 (S235).

Next, the centroid acquisition unit 18a determines whether or not the color difference ΔE that is calculated in S235 is equal to or less than a specified color difference E1 (S236).

When it is determined in S236 that the color difference ΔE is larger than the color difference E1, the centroid acquisition unit 18adetermines whether or not the color difference ΔE that is calculated in S235 is equal to or greater than a specified color difference E2 (S237). Here, the color difference E2 is greater than the color difference E1.

When it is determined in S237 that the color difference ΔE is less than the color difference E2, the centroid acquisition unit 18a, as in the processing in S232, calculates the hue angle of the cluster centroid Aₖ in RGB color space (S238).

Next, the centroid acquisition unit 18a calculates an angular difference Deg between the RGB value Lⱼ and the cluster centroid Aₖ based on the hue angle that is calculated in S232 and the hue angle that is calculated in S238 (S239). Here, the angular difference Deg is the absolute value of the difference between the hue angle calculated in S232 and the hue angle calculated in S238.

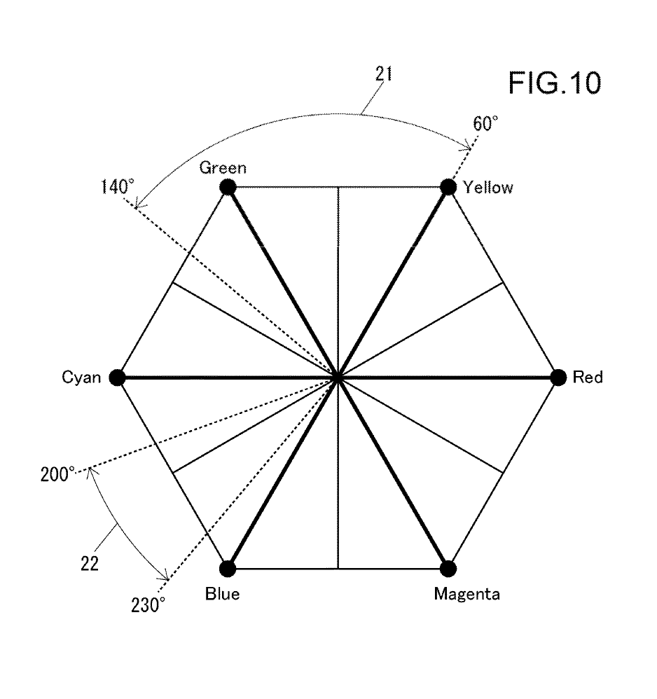

After the processing in S239, the centroid acquisition unit 18a determines whether or not the hue angle that is calculated in S232 and the hue angle that is calculated in S238 are both within a specified angle range 21 (refer to FIG. 10) near green (S240).

FIG. 10 illustrates an example of a color range for which special correction has been performed in the processing illustrated in FIG. 8.

As illustrated in FIG. 10, the specified angle range 21 near green is the angle range 60° to 140°. The angle range 21 is an angle range near green that includes green and is for colors of a plant leaf. The colors of a leaf are various colors near green that are a little different from each other. However, a person generally recognizes various colors that are only a little different from each other as being almost the same color. In other words, there is color that many people remember as the ideal color of a leaf, that is, there is a memory color for a leaf. The angle range 21 is an angle range that includes the memory color for a leaf, and is a range in which it becomes easy to handle two colors that are included in the range as the same cluster color.

A specified angle range 22 near blue is an angle range) 200° (−160°) to 230° (−130°). The angle range 22 is an angle range near blue for the color of sky. As the color of sky, there are various colors near blue that are only a little different from each other. However, a person generally recognizes these colors that are only a little different from each other as almost the same color. In other words, there is color that many people remember as the ideal color of sky, that is, there is a memory color for sky. The angle range 22 is an angle range that includes the memory color for sky, and is a range in which it becomes easy to handle two colors that are included in the range as the same cluster color.

As illustrated in FIG. 8, when it is determined in S240 that the hue angle that is calculated in S232 and the hue angle that is calculated in S238 are both in the angle range 21, the centroid acquisition unit 18a obtains a new angular difference Deg by multiplying the angular difference Deg that is calculated in S239 by a coefficient 0.25 (S241). The coefficient 0.25 is an example and depends on the design.

When it is determined in S240 that at least one of the hue angle that is calculated in S232 and the hue angle that is calculated in S238 is not in the angle range 21, the centroid acquisition unit 18a determines whether or not the hue angle that is calculated in S232 and the hue angle that is calculated in S238 are both within the specified angle range 22 (refer to FIG. 10) near blue (S242).

When it is determined in S242 that the hue angle that is calculated in S232 and the hue angle that is calculated in S238 are both in the angle range 22, the centroid acquisition unit 18a obtains a new angular difference Deg by multiplying the angular difference Deg that is calculated in S239 by a coefficient 0.8 (S243). The coefficient 0.8 is an example and depends on the design.

When it is determined in S42 that at least one of the hue angle that is calculated in S232 and the hue angle that is calculated in S238 is not in the angle range 22, or when executing the processing of S241 or S243, the centroid acquisition unit 18a determines whether or not the angular difference Deg is equal to or less than a specified angular difference Deg1 (S244).

When it is determined in S237 that the color difference ΔE is equal to or greater than the color difference E2, or when it is determined in S244 that the angular difference Deg is greater than the angular difference Deg1, the centroid acquisition unit 18a determines whether or not the value of the variable k is the same as the value of the variable i (S245).

When it is determined in S245 that the value of the variable k is the same as the value of the variable i, the centroid acquisition unit 18a adds 1 to the variable k (S246) and executes the processing of S234.

When it is determined in S236 that the color difference ΔE is equal to or less than the color difference E1, or when it is determined in S244 that the angular difference Deg is equal to or less than the angular difference Deg1, the centroid acquisition unit 18achanges the registration flag Fᵢ to False (S247), and the processing illustrated in FIG. 8 ends.

When it is determined in S245 that the value of the variable k is the same as the value of the variable i, the centroid acquisition unit 18a ends the processing illustrated in FIG. 8.

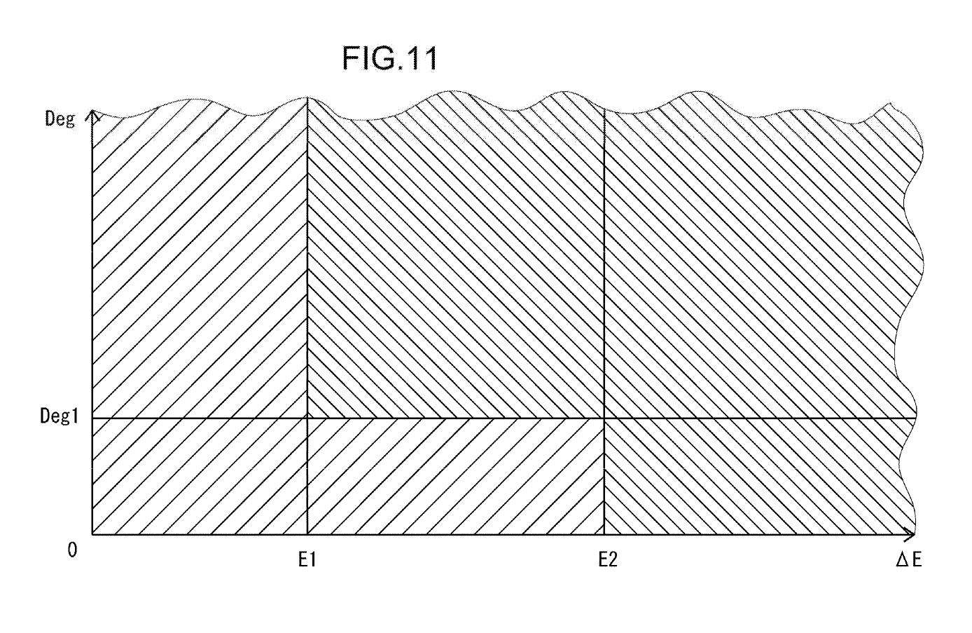

FIG. 11 illustrates the judgment criteria in the processing illustrated in FIG. 8.

As illustrated in FIG. 11, when the color difference ΔE is equal to or less than the color difference E1 for any registered cluster centroid Aₖ (YES in S236), the RGB value Lⱼ is considered to be an approximate color of the cluster centroid Aₖ, so should belong to the same cluster as that cluster centroid Aₖ, and is not set as a candidate for a new cluster centroid (S247). Moreover, even when the color difference ΔE is greater than the color difference E1 and less than the color difference E2, and the angular difference Deg is equal to or less than the angular difference Deg1 (YES in S244) for any registered cluster centroid Aₖ, the RGB value Lⱼ is such that even though at least one of the brightness and saturation is a little different than that of the cluster centroid Aₖ, the hue is close, so from the aspect of human perception, can also be considered to be an approximate color of that cluster centroid Aₖ. Therefore, the RGB value Lⱼ should belong to the same cluster as that of the cluster centroid Aₖ, and is not set as a candidate for a new cluster centroid (S247).

However, when the color difference ΔE is equal to or greater than the color difference E2 (YES in S237), or when the color difference ΔE is greater than the color difference E1 and less than the color difference E2 and the angular difference Deg is greater than the angular difference Deg1 (YES in S244) for any of the registered cluster centroids Aₖ, the RGB value Lⱼ should belong to a cluster that is different than any of the registered cluster centroids Aₖ, so is set as a candidate for a new cluster centroid (S208). When the hue angles of the RGB value Lⱼ and the cluster centroid Aₖ are both included in the angle range 21 or angle range 22, the angular difference Deg is made to be smaller (S241 or S243). In other words, when the hue angles of the RGB value Lⱼ and the cluster centroid Aₖ are both included in the angle range 21 or angle range 22, the angular difference Deg1 is substantially greater than when at least one of the hue angle of the RGB value Lⱼ and the hue angle of the cluster centroid Aₖ is not included in either the angle range 21 or the angle range 22.

As explained above, in the centroid initial value calculation process illustrated in FIG. 6, when there are plural RGB values Lⱼ that are supposed to belong to the same cluster, the RGB value Lⱼ having the highest frequency is registered as the cluster centroid. The number of cluster centroids that will be registered, or in other words, the number of clusters is i.

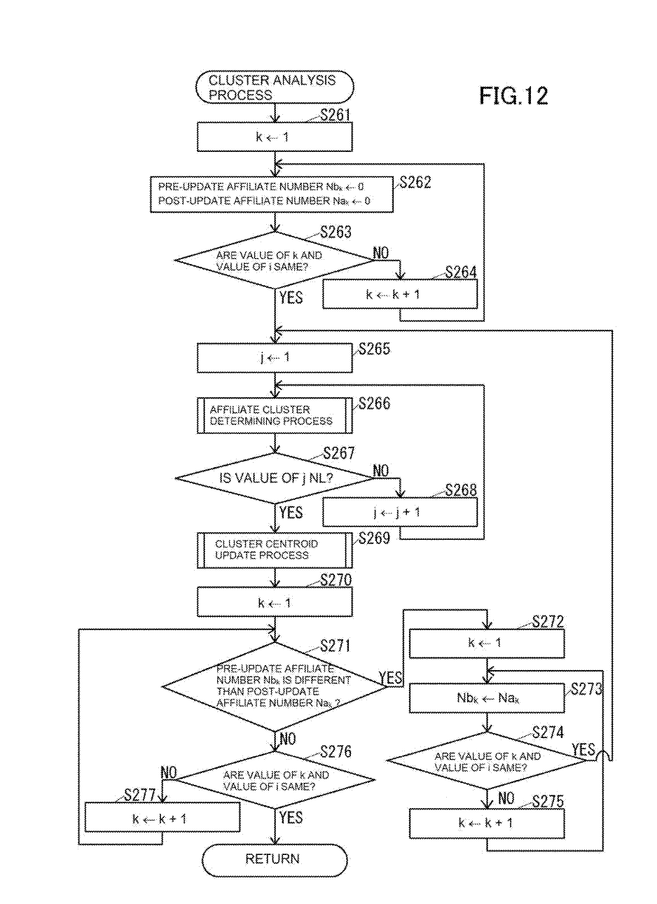

FIG. 12 is a flowchart of the cluster analysis process in S164.

As illustrated in FIG. 12, the centroid acquisition unit 18a substitutes 1 for variable k (S261).

Next, as the number of RGB values of the RGB values of the data string ML that belong to the cluster Cₖ (hereafter, referred to as the “affiliate number”), the centroid acquisition unit 18a initializes the affiliate number before updating the cluster centroid Aₖ (hereafter, referred to as the “pre-updated affiliate number”) Nbₖ, and the affiliate number after updating the cluster centroid Aₖ (hereafter, referred to as the “post-update affiliate number”) Naₖ to 0 (S262). Here, the cluster Cₖ is a cluster to which the cluster centroid Aₖ belongs.

After the processing in S262, the centroid acquisition unit 18a determines whether or not the value of the variable k and the value of the variable i are the same (S263).

When it is determined in S263 that the value of the variable k and the value of the variable i are not the same, the centroid acquisition unit 18a adds 1 to the variable k (S264), and executes the processing of S262.

When it is determined in S263 that the value of the variable k and the value of the variable i are the same, the centroid acquisition unit 18a substitutes 1 for the variable j (S265).

Next, the centroid acquisition unit 18a executes an affiliate cluster determining process that determines a cluster Cₖ to which the RGB value Lⱼ belongs (S266).

Next, after the processing of S266, the centroid acquisition unit 18a determines whether or not the value of the variable j is the number of data NL (S267).

When it is determined in S267 that the value of the variable j is not the number of data NL, the centroid acquisition unit 18a adds 1 to the variable j (S268), and executes the processing of S266.

When it is determined in S267 that the value of the variable j is the number of data NL, the centroid acquisition unit 18a executes a cluster centroid update process for updating the cluster centroid based on the RGB value and frequency in the data string ML, and determining result in S266 of whether the RGB value belongs to any cluster (S269).

Next, the centroid acquisition unit 18a substitutes 1 for the variable k (S270).

Next, the centroid acquisition unit 18a determines whether or not the pre-update affiliate number Nbₖ of the cluster centroid Aₖ is different than the post-update affiliate number Naₖ of the cluster centroid Aₖ (S271).

When it is determined in S271 that the pre-update affiliate number Nbₖ of the cluster centroid Aₖ is different than the post-update affiliate number Naₖ of the cluster centroid Aₖ, the centroid acquisition unit 18a substitutes 1 for the variable k (S272).

Next, the centroid acquisition unit 18asets the pre-update affiliate number Nbₖ of the cluster centroid Aₖ to be the post-update affiliate number Naₖ of the cluster centroid Aₖ (S273).

The centroid acquisition unit 18athen determines whether or not the value of the variable k and the value of the variable i are the same (S274).

When it is determined in S274 that the value of the variable k and the value of the variable i are not the same, the centroid acquisition unit 18a adds 1 to the variable k (S275), and executes the processing of S273.

When it is determined in S274 that the value of the variable k and the value of the variable i are the same, the centroid acquisition unit 18a executes the processing of S265.

When it is determined in S271 that the pre-update affiliate number Nbₖ of the cluster centroid Aₖ is not different than the post-update affiliate number Naₖ of the cluster centroid Aₖ, the centroid acquisition unit 18a determines whether or not the value of the variable k and the value of the variable i are the same (S276).

When it is determined in S276 that the value of the variable k is not the same as the value of the variable i, the centroid acquisition unit 18a adds 1 to the variable k (S277), and executes the processing of S271.

When it is determined in S276 that the value of the variable k is the same as the value of the variable i, the centroid acquisition unit 18a ends the process illustrated in FIG. 12.

The process illustrated in FIG. 12 is such that updating the cluster centroid is performed until there is no variation in the affiliate number for each cluster before and after updating the cluster centroid (YES in S276) (S269). Therefore, the centroid acquisition unit 18a is able to find the most suitable cluster centroid in the input image.

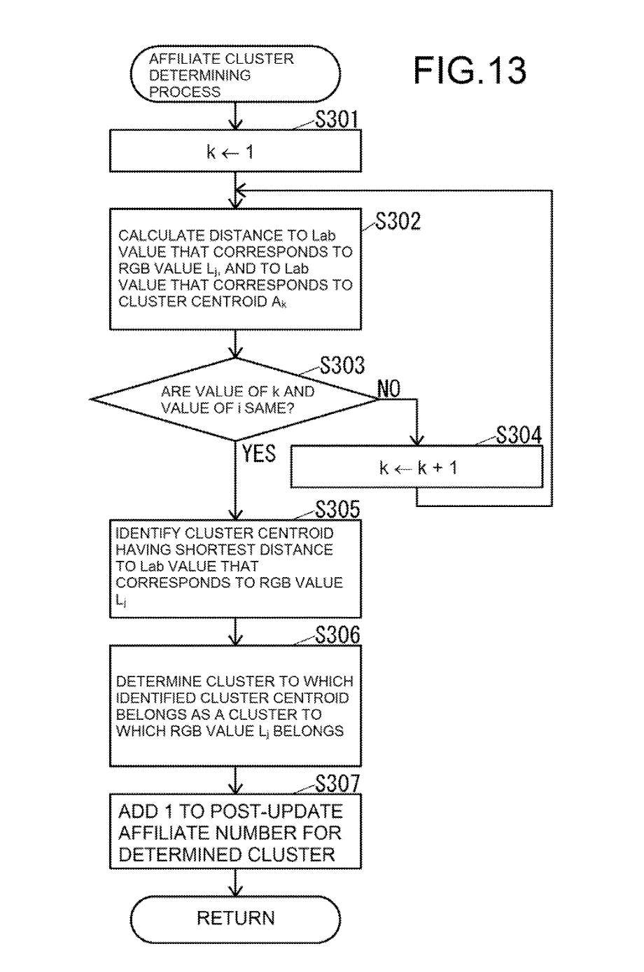

FIG. 13 is a flowchart of the affiliate cluster determining process of S266.

There are many methods for determining which cluster the RGB value Lⱼ belongs to, for example there is a method of using the method of least squares. Here, a method of using least squares will be explained.

As illustrated in FIG. 13, the centroid acquisition unit 18a substitutes 1 for the variable k (S301).

Next, the centroid acquisition unit 18a calculates the distance in Lab color space of the Lab value that corresponds to the RGB value Lⱼ and the Lab value that corresponds to the cluster centroid Aₖ (S302).

The centroid acquisition unit 18a then determines whether or not the value of the variable k and the value of the variable i are the same (S303).

When it is determined in S303 that the value of the variable k and the value of the variable i are not the same, the centroid acquisition unit 18a adds 1 to the variable k (S304), and executes the processing of S302.

When it is determined in S303 that the value of the variable k and the value of the variable i are the same, the centroid acquisition unit 18a identifies the cluster centroid having the shortest distance to the Lab value that corresponds to the RGB value Lⱼ based on the distance that is calculated in S302 (S305). When there are plural cluster centroids having the shortest distance to the Lab value that corresponds to the RGB value Lⱼ, the centroid acquisition unit 18a identifies in S305 a cluster centroid from among these plural cluster centroids for the RGB value having the highest frequency immediately after the processing of S163.

Next, the centroid acquisition unit 18a determines the cluster to which the cluster centroid belongs that is identified in S305 as the cluster to which the RGB value Lⱼ belongs (S306). For example, when the cluster centroid A₁₀ is identified in S305, the centroid acquisition unit 18a determines the cluster C₁₀ as the cluster to which the RGB value Lⱼ belongs.

The centroid acquisition unit 18a then adds 1 to the post-update affiliate number of the cluster that is determine in S306 (S307), and ends the processing that is illustrated in FIG. 13. For example, when the cluster C₁₀ is determine in S306, the centroid acquisition unit 18a adds 1 to the post-update affiliate number Na₁₀ of the cluster C₁₀.

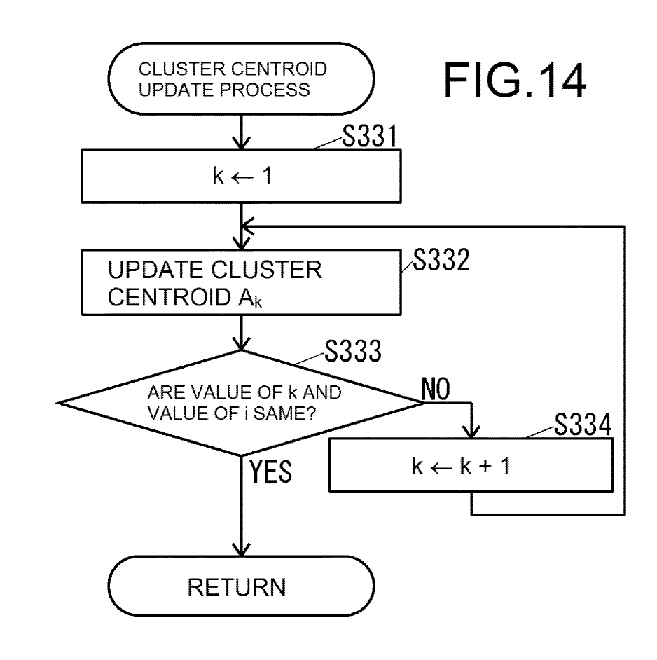

FIG. 14 is a flowchart of the cluster centroid update process of S269.

As illustrated in FIG. 14, the centroid acquisition unit 18a substitutes 1 for the variable k (S331).

Next, as illustrated in Equation 1, the centroid acquisition unit 18aupdates the cluster centroid Aₖ by finding the average for each of the R value, B value and G value that are weighted by the frequency (S332). In Equation 1, Rₖ, Gₖ and Bₖ are the R value, G value and B value, respectively, of the updated cluster centroid Aₖ . Rₗ, Gₗ and Bₗ are the R value, G value and B value, respectively, of the RGB values that belong to the cluster Cₖ. Histₗ is the frequency in the data string ML of the RGB values that belong to the cluster Cₖ. For example, when the RGB values L₁₀, L₂₀ and L₃₀ belong to the cluster Cₖ, the R value and frequency of the RGB value L₁₀ are taken to be R₁₀ and Hist₁₀, respectively, the R value and frequency of the RGB value L₂₀ are taken to be R₂₀ and Hist₂₀, respectively, and the R value and frequency of the RGB value L₃₀ are taken to be R₃₀ and Hist₃₀, respectively. In that case, Rₖ becomes (R₁₀·Hist₁₀+R₂₀·Hist₂₀+R₃₀·Hist₃₀)/(Hist₁₀+Hist₂₀+Hist₃₀).

$${R}_{k} = \frac{{\sum }_{l} {R}_{l} \cdot {Hist}_{l}}{{\sum }_{l} {Hist}_{l}} \\ {G}_{k} = \frac{{\sum }_{l} {G}_{l} \cdot {Hist}_{l}}{{\sum }_{l} {Hist}_{l}} \\ {B}_{k} = \frac{{\sum }_{l} {B}_{l} \cdot {Hist}_{l}}{{\sum }_{l} {Hist}_{l}} \qquad [ Equation 1 ]$$

After the processing of S332, the centroid acquisition unit 18adetermines whether or not the value of variable k and the value of variable i are the same (S333).

When it is determined in S333 that the value of variable k and the value of variable i are not the same, the centroid acquisition unit 18aadds 1 to the variable k (S334), and executes the processing of S332.

When it is determined in S333 that the value of variable k and the value of variable i are the same, the centroid acquisition unit 18a ends the processing illustrated in FIG. 14.

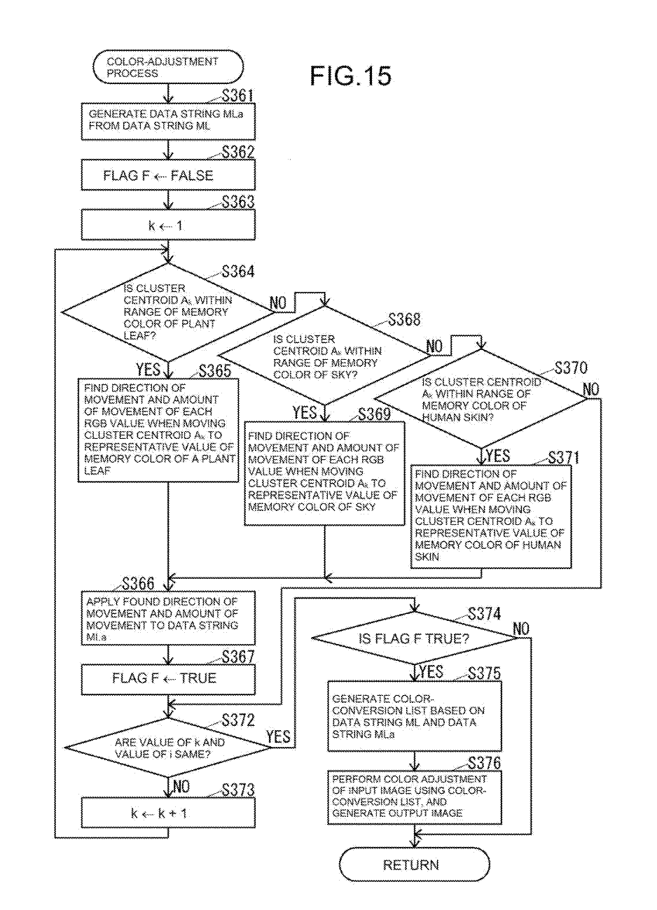

FIG. 15 is a flowchart of the color-adjustment process of S103.

As illustrated in FIG. 15, the color-conversion-information generation unit 18b copies all of the RGB values of the data string ML and generates a data string MLa (S361).

Next, the color-conversion-information generation unit 18b initializes the flag F to False (S362). The flag F can be the value True or False.

After the processing of S362, the color-conversion-information generation unit 18bsubstitutes 1 for the variable k (S363).

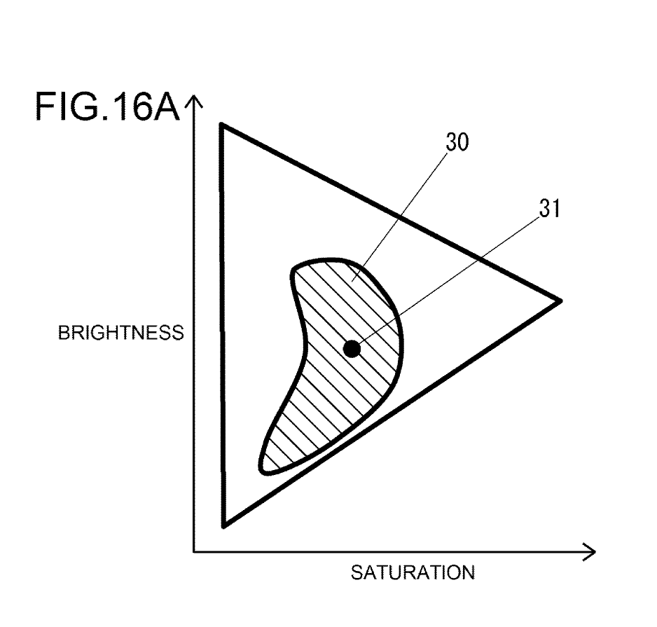

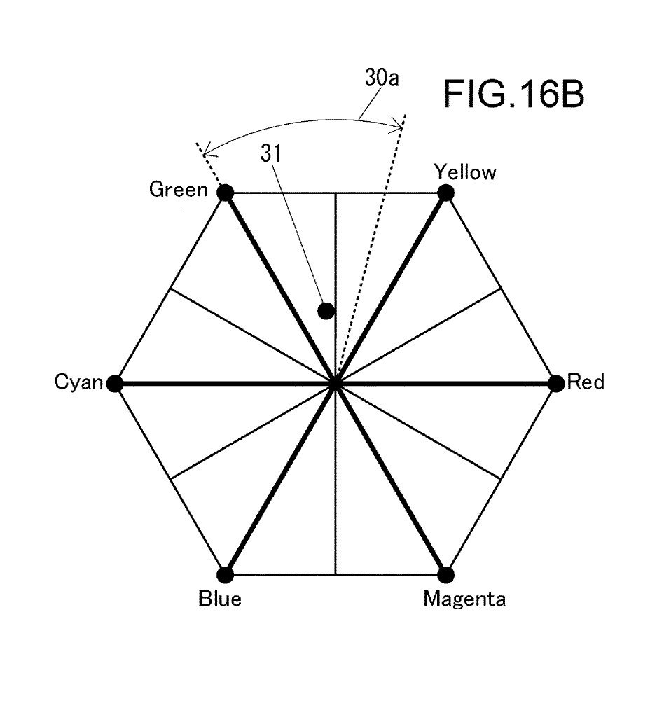

Next, the color-conversion-information generation unit 18b determines whether or not the cluster centroid Aₖ is within a range 30 (refer to FIG. 16A and FIG. 16B) for the memory color of a plant leaf (S364).

FIG. 16A illustrates the hue plane that includes the range 30 of the memory color of a plant leaf. FIG. 16B illustrates the angle range 30a of the range 30.

The hue plane illustrated in FIG. 16A is a hue plane that includes a representative value 31 that indicates a representative color of the memory color of a plant leaf. The range 30 is not the size and the shape illustrated in FIG. 16A covering the entire area of the angle range 30a illustrated in FIG. 16B. The angle range 30a is included in the angle range 21. The manufacturer of the MFP 10 analyzes several hundreds of kinds of images beforehand, for example, and sets the range 30 and the representative value 31.

As illustrated in FIG. 15, when it is determined in S364, that the cluster centroid Aₖ is within the range 30 of the memory color of a plant leaf, the color-conversion-information generation unit 18b finds the direction of movement and amount of movement of each RGB value of the data string MLa when the cluster centroid Aₖ is moved to the representative value 31 of the memory color of a plant leaf (S365).

The MFP 10 employs a method as a method for changing colors that first moves the cluster centroid Aₖ in the direction of the hue angle, and then moves the cluster centroid Aₖ within the hue plane. Changing the color is performed in Lch color space.

First, by moving the cluster centroid Aₖ in the hue angle of the representative value 31 of the memory color of a plant leaf, a point P is set in the hue plane that includes the representative value 31. Next, the point P is moved to the representative value 31 on the hue plane that includes the representative value 31.

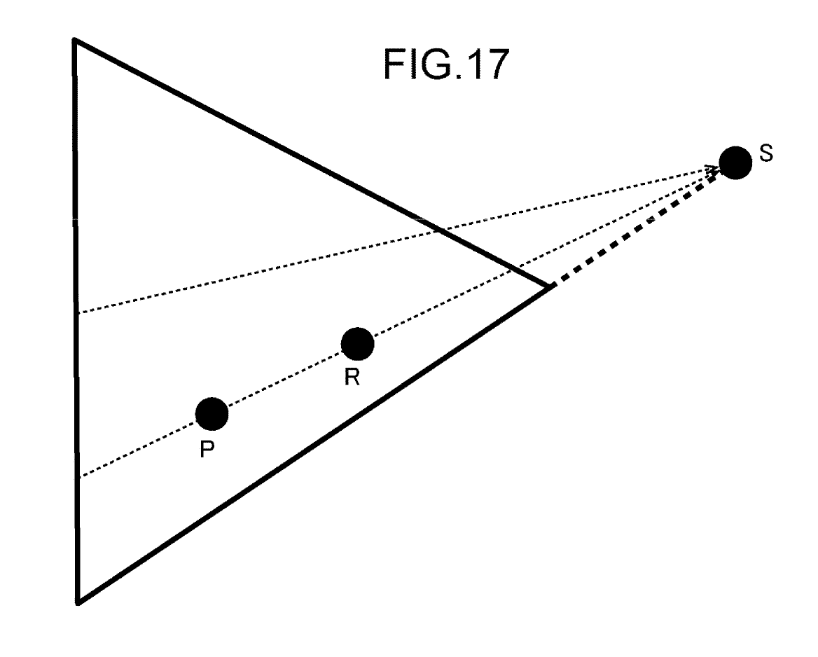

FIG. 17 illustrates the direction of movement of the cluster centroid Aₖ in the hue plane that includes the representative value 31 of the memory color of a plant leaf.

In FIG. 17, the cluster centroid Aₖ is expressed as point P, and the representative value 31 of the memory color of a plant leaf is expressed as point R. In regard to the color around the representative value 31 of the memory color of a plant leaf, the straight line PR forms a vector in the direction toward a point S where the line PR crosses an extending line of the bottom line in the brightness direction in the hue plane. This is because a leaf can appear to be beautiful when the brightness is increased by raising the saturation.

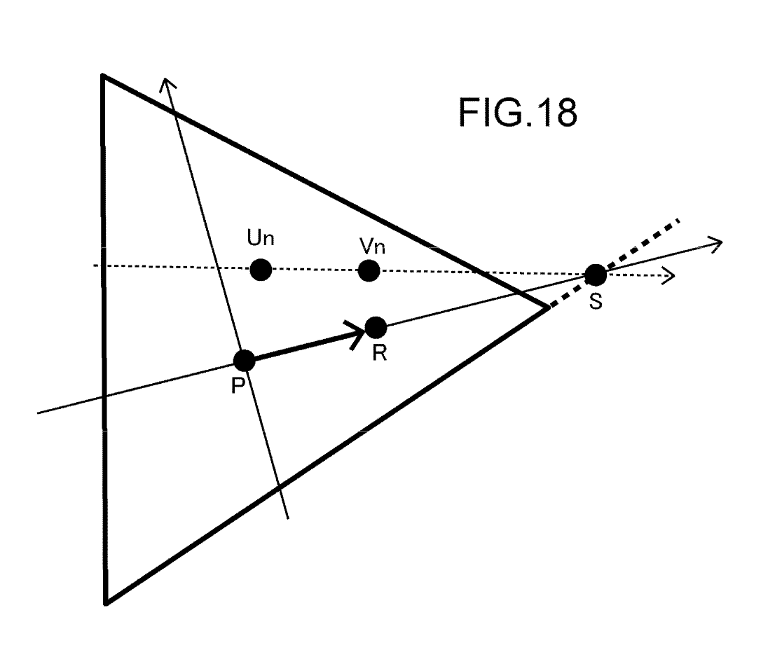

FIG. 18 illustrates the direction of movement of color in the hue plane that includes the representative value 31 of the memory color of a plant leaf.

As illustrated in FIG. 18, a point Un that is the color around the representative value 31 of the memory color of a plant leaf is moved in the direction toward point S when the cluster centroid Aₖ is moved to the representative value 31 of the memory color of a plant leaf and becomes point Vn.

Here, the size of the vector UnVn is different than the size of the vector PR. The ratio of the size of the vector PR and the vector UnVn is determined according to the positional relationship between point P and point Un.

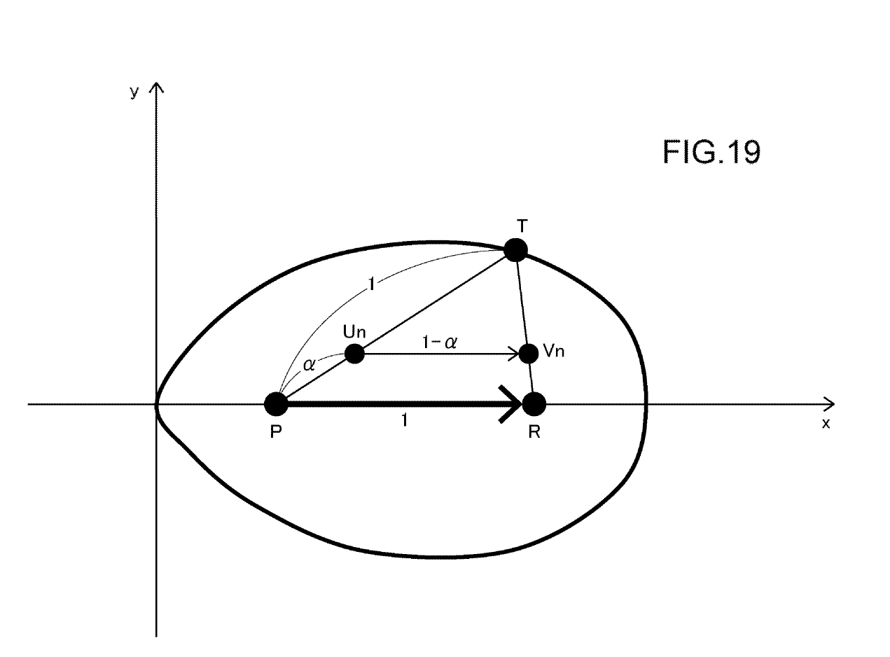

FIG. 19 illustrates the amount of movement of the color in the hue plane that includes the representative value 31 of the memory color of a plant leaf.

The vector PR illustrated in FIG. 18 is taken to be the x-axis component, and the straight line that perpendicularly crosses the vector PR is taken to be the y-axis component, so when performing rotation and parallel movement of the coordinate system by performing affine transformation, the result is as illustrated in FIG. 19.

As illustrated in FIG. 19, the specific curve (for example, an egg shaped curve) is considered based on point P and point R. A point T is obtained where that curve and the straight line PUn intersect. Triangles ΔTUnVn and ΔTPR are similar, so when line segment PT:line segment PUn=1:α, line segment PR: line segment UnVn=1:(1−α). Here, the lengths of the line segment PT and line segment PUn are obtained by calculation. Therefore, the ratio (1−α) of the line segment UnVn with respect to the line segment PR is obtained by calculation. In other words, the size of the vector UnVn with respect to the size of the vector PR is a multiple of (1−α).

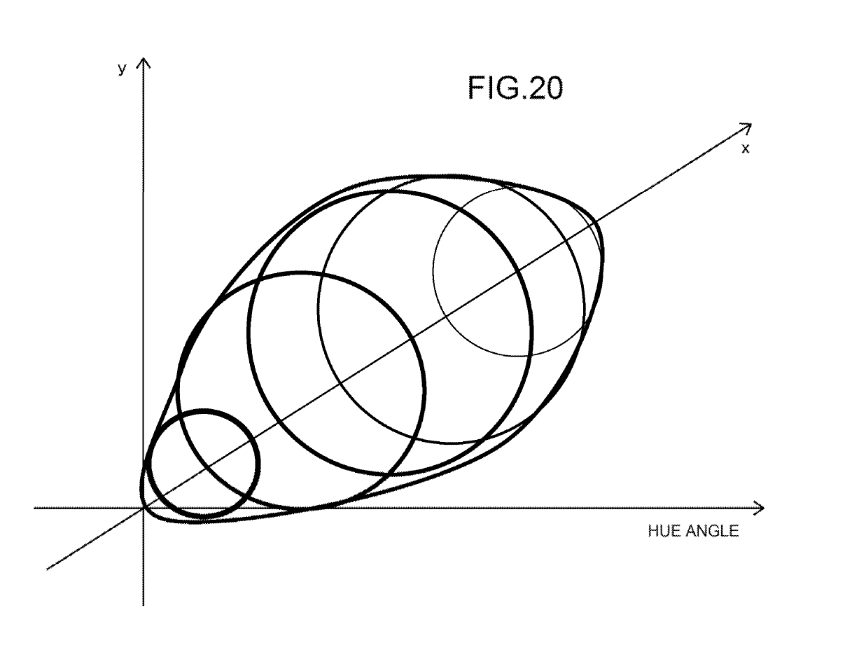

FIG. 20 illustrates the range of movement in three-dimensional space of the color around the representative value 31 of the memory color of a plant leaf.

Color space is three dimensional and not two-dimensional, so it is necessary to define the dimensions of the hue angle component. As illustrated in FIG. 20, when the y-axis component and hue angle component are viewed in two dimensions, the result is defined as being a circle. Therefore, the hue angle component is handled by the same amount as the y component. In other words, the color around the representative value 31 of the memory color of a plant leaf is such that the amount of movement in the hue angle direction can also be calculated by multiplication by a movement ratio that corresponds to the distance from the point P.

As illustrated in FIG. 15, after the processing of S365, the color-conversion-information generation unit 18b applies the direction of movement and amount of movement that are found in S365 to the data string MLa (S366), and sets the flag F to True (S367).

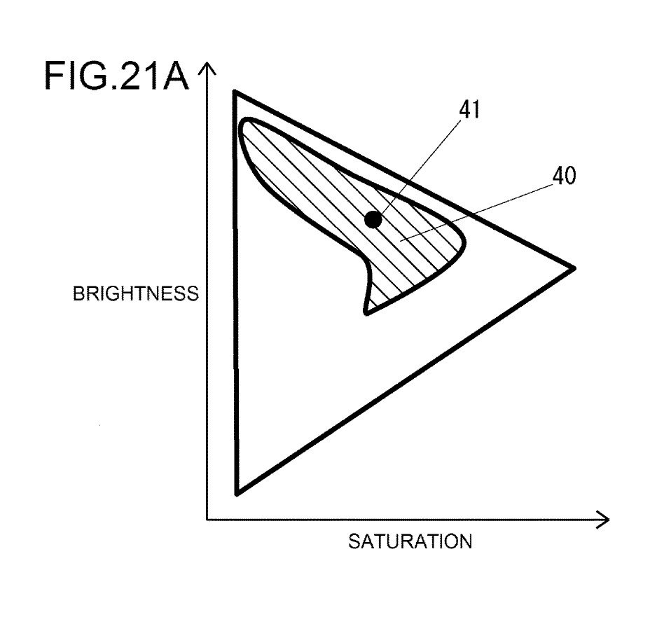

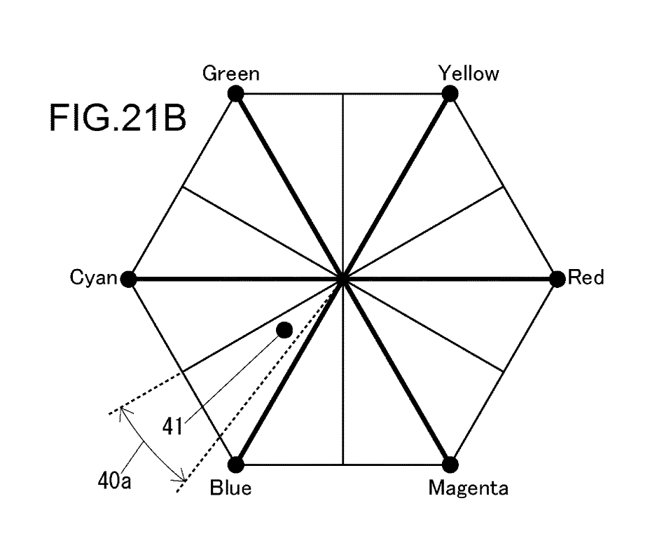

When it is determined in S364 that the cluster centroid Aₖ is not within the range 30 of the memory color of a plant leaf, the color-conversion-information generation unit 18b determines whether or not the cluster centroid Aₖ is within the range 40 of the memory color of sky (refer to FIG. 21A and FIG. 21B) (S368).

FIG. 21A illustrates a hue plane that includes the range 40 of the memory color of sky. FIG. 21B illustrates the angle range 40a of the range 40.

The hue plane illustrated in FIG. 21A is a hue plane that includes a representative value 41 that indicates a representative color of the memory color of sky. The range 40 is not the size and shape illustrated in FIG. 21A covering the entire area of the angle range 40a illustrated in FIG. 21B. The angle range 40a is included in the angle range 22. The manufacturer of the MFP 10 analyzes several hundreds of kinds of images beforehand, for example, and sets the range 40 and the representative value 41. However, for the representative value 41, only the hue is determined.

As illustrated in FIG. 15, when it is determined in S368 that the cluster centroid Aₖ is within the range 40 of the memory color of sky, the color-conversion-information generation unit 18b finds the direction of movement and the amount of movement of each of the RGB values of the data string MLa when the cluster centroid Aₖ is moved to the representative value 41 of the memory color of sky (S369).

Here, the MFP 10 employs a method as a method for changing colors that first moves the cluster centroid Aₖ in the direction of the hue angle, and then moves the cluster centroid Aₖ within the hue plane. Changing the color is performed in Lch color space.

First, by moving the cluster centroid Aₖ in the hue angle of the representative value 41 of the memory color of sky, a point P is set in the hue plane that includes the representative value 41. Next, the point P is moved to the representative value 41 on the hue plane that includes the representative value 41.

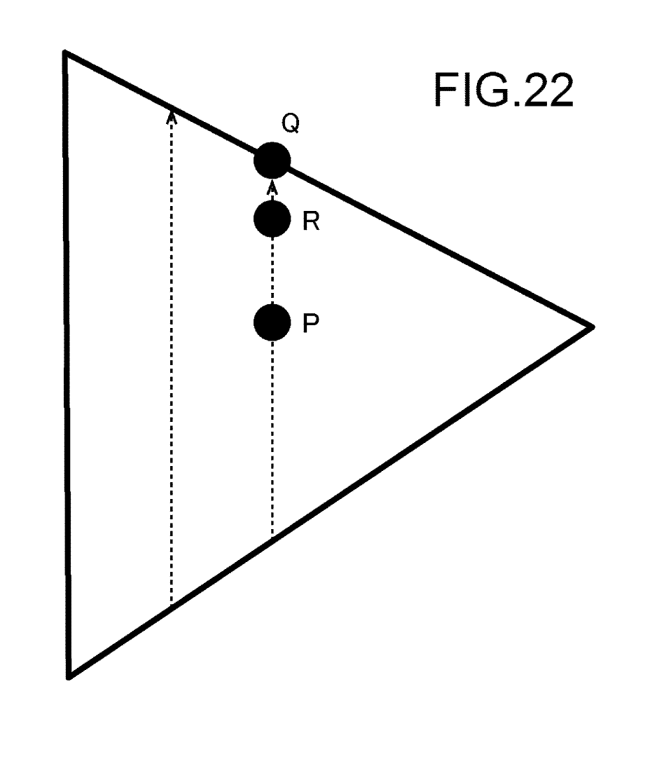

FIG. 22 illustrates the direction of movement of the cluster centroid Aₖ in the hue plane that includes the representative value 41 of the memory color of sky.

In FIG. 22, the cluster centroid Aₖ is expressed as point P, and the representative value 41 of the memory color of sky is expressed as point R. Point R is a point on a line segment QP that connects the intersecting point Q between a line extending in a direction in which only the brightness component extends upward from point P and a line on the top end of the brightness direction of the hue plane, and point P, and is a point at a position at a distance that is a specified ratio such as 0.8 times the length of the line segment QP from point P. In regard to the color around the representative value 41 of the memory color of sky, a vector is formed in the direction that only the brightness component rises. This is because the sky can appear to be beautiful when bright.

The amount of movement of each of the RGB values of the data string MLa when moving the cluster centroid Aₖ to the representative value 41 of the memory color of sky can be found in the same way as the amount of movement of each of the RGB values of the data string MLa when moving the cluster centroid Aₖ to the representative value 31 of the memory color of a plant leaf.

As illustrated in FIG. 15, after the processing of S369, the color-conversion-information generation unit 18bexecutes the processing of S366.

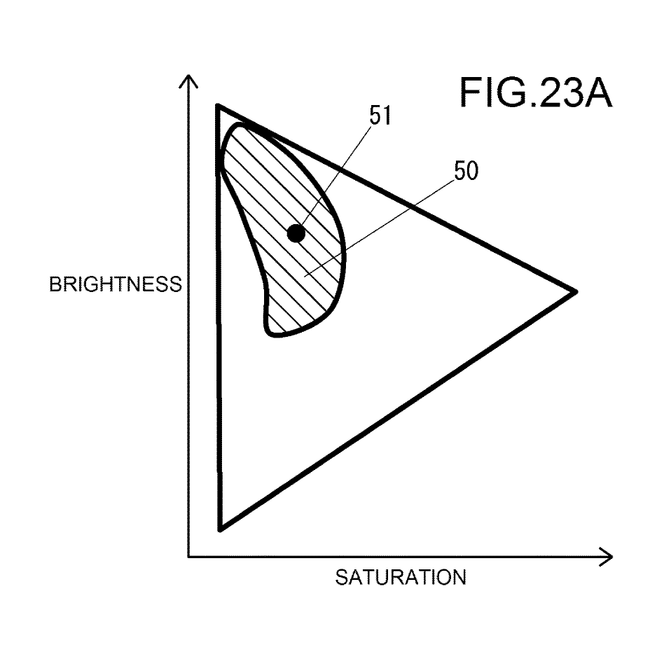

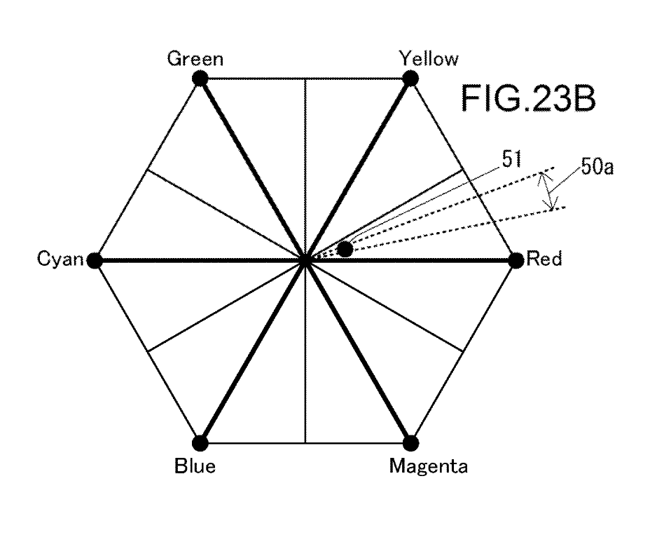

When it is determined in S368 that the cluster centroid Aₖ is not within the range 40 of the memory color of sky, the color-conversion-information generation unit 18b determines whether or not the cluster centroid Aₖ is within the range 50 (refer to FIG. 23A and FIG. 23B) of the memory color of human skin (S370).

FIG. 23A illustrates a hue plane that includes the range 50 of the memory color of human skin. FIG. 23B illustrates the angle range 50a of the range 50.

The hue plane illustrated in FIG. 23A is a hue plane that includes a representative value 51 that indicates a representative color of the memory color of human skin. The range 50 is not the size and shape illustrated in FIG. 23A covering the entire area of the angle range 50a illustrated in FIG. 23B. As human skin color, there are various colors near skin color that differ a little from each other. However, a person generally recognizes these various colors that differ only a little as being almost the same color. In other words, there is a color that many people remember as the ideal color of skin, or in other words, there is a memory color for skin. The range 50 is a range indicating the memory color of skin. The manufacturer of the MFP 10 analyzes several hundreds of kinds of images beforehand, for example, and sets the range 50 and the representative value 51.

As illustrated in FIG. 15, when it is determined in S370 that the cluster centroid Aₖ is within the range 50 of the memory color of human skin, the color-conversion-information generation unit 18b finds the direction of movement and amount of movement of each RGB value of the data string MLa when moving the cluster centroid Aₖ to the representative value 51 of the memory color of human skin (S371).

Here, the MFP 10 employs a method as a method for changing colors that first moves the cluster centroid Aₖ in the direction of the hue angle, and then moves the cluster centroid Aₖ within the hue plane. Changing the color is performed in Lch color space.

First, by moving the cluster centroid Aₖ in the hue angle of the representative value 51 of the memory color of human skin, a point P is set in the hue plane that includes the representative value 51. Next, the point P is moved to the representative value 51 on the hue plane that includes the representative value 51.

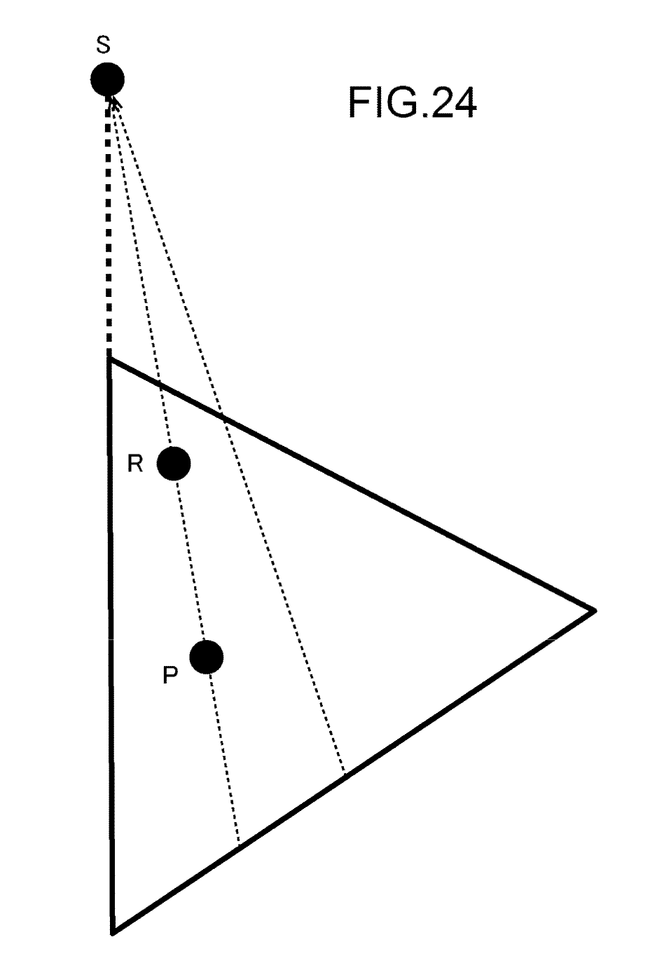

FIG. 24 illustrates the direction of movement of the cluster centroid Aₖ in the hue plane that includes the representative value 51 of the memory color of human skin.

In FIG. 24, the cluster centroid Aₖ is expressed as point P, and the representative value 51 of the memory color of human skin is expressed as point R. In regard to the color around the representative value 51 of the memory color of human skin, the straight line PR forms a vector in the direction toward a point S where the line PR intersects with an extending line of the gray axis. This is because skin can appear to be more beautiful when brighter and lighter.

The amount of movement of each RGB value in the data string MLa when the cluster centroid Aₖ is moved to the representative value 51 of the memory color of human skin can be found in the same way as the amount of movement of each of the RGB values in the data string MLa when moving the cluster centroid Aₖ to the representative color 31 of the memory color of a plant leaf.

As illustrated in FIG. 15, after the processing of S371, the color-conversion-information generation unit 18b executes the processing of S366.

When it is determined in S370 that the cluster centroid Aₖ is not within the range 50 of the memory color of human skin, or when the processing of S367 is finished, the color-conversion-information generation unit 18b determines whether or not the value of the variable k and the value of the variable i are the same (S372).

When it is determined in S372 that the value of the variable k and the value of the variable i are not the same, the color-conversion-information generation unit 18b adds 1 to the variable k (S373), and executes the processing of S364.

When it is determined in S372 that the value of the variable k and the value of the variable i are the same, the color-conversion-information generation unit 18bdetermines whether or not the flag F is True (S374).

When it is determined in S374 that the flag F is True, the color-conversion-information generation unit 18b generates a color-conversion list that converts the RGB values in the data string ML to the RGB values in the data string MLa based on the RGB values in the data string ML and the RGB values in the data string MLa (S375).

Next, the output-image generation unit 18cuses the color-conversion list that is generated in S375 and converts the color of the input image, or in other words, generates an output image by performing color adjustment (S376), and ends the processing illustrated in FIG. 15.

When it is determined in S374 that the flag F is False, the color-conversion-information generation unit 18b ends the processing illustrated in FIG. 15. In other words, when it is determined in S374 that the flag F is False, color adjustment is not performed on the input image.

As explained above, when the centroid of a cluster, which is a collection of approximate colors in the input image, in other words, cluster centroid is included in a range 30, 40 or 50 of a specific memory color in color space (YES in S364, YES in S368 or YES in S370), the MFP 10 generates an output image by converting the colors of the input image so that this cluster centroid is moved to the representative color of this memory color (S376). Therefore, it is possible to convert the color of an input image and generate an output image in which a specific memory color has been enhanced.

With this configuration, the image-forming device of this disclosure is such that when the hue angles of two target colors are included in a specific angle range, the difference in the hue angle for determining that the two target colors are approximate colors is larger than when the hue angles of two target colors are not included in the specific angle range. Therefore, two target colors that are included in a specific angle range that includes the hue angle of a specific range, when compared with two target colors that are not included within this angle range, have a strong tendency to be determined as being the same cluster, and it is possible to suppress the possibility of many cluster centroids being included in the specific range. Consequently, the image-forming device of the present disclosure is able to suppress the possibility of a color of an input image being converted so that plural cluster centroids are moved to the same color, and this it is able to generate a natural output image in which the color within a specific range has been enhanced.

The MFP 10 is such that when the hue angles of both the RGB color Lⱼ and the cluster centroid Aₖ are both included in an angle range 21, 22 (YES in S240, or YES in S242), the difference in the hue angle, or in other words, the angular difference Deg1 for determining that the RGB colors Lⱼ and the cluster centroids Aₖ are approximate colors, is substantially larger than when the hue angle of at least one of the RGB color Lⱼ and the cluster centroid Aₖ is not included in an angle range 21, 22 (NO in S240, or NO in S242). Therefore, there is a stronger tendency to determine as the same cluster when comparing the hue angle 30, 40 of a specific memory color, that is colors included in an angle range 21, 22, which includes a angle range 30a, 40a, with colors not included in the angle range 21, 22, and thus it is possible to suppress the possibility that many cluster centroids will be included in the range 30, 40. Therefore, the MFP 10 is able to suppress the possibility that the color of an input image will be converted so that many cluster centroids will be moved to the same color, and thus is able to generate a natural output image in which the color in the range 30, 40 is enhanced.

In the processing illustrated in FIG. 15, in this embodiment the color of a plant leaf, the color of sky and the color of human skin are used as the target for the memory color. However, other memory colors may also be used as the target.

With this configuration, the image-forming device of this disclosure generates an output image by converting the color of an input image so that the centroid is moved to the representative color of the memory color when the centroid of a cluster, which is a collection of approximate colors in an input image, is included in a range of a specific memory color in color space. Therefore, it is possible to convert the color of an input image and generate an output image in which a specific memory color is enhanced.

Moreover, in this embodiment, the memory color taken to be the target in the process illustrated in FIG. 8 is only part of the memory colors that are taken to be targets in the process illustrated in FIG. 15. However, all of the memory colors that are taken to be the targets in the process illustrated in FIG. 15 could also be taken to be the targets in the process in FIG. 8.

In this embodiment, an output image is generated in which a memory color is enhanced, however, it is also possible to generate an output image in a specific color other than a memory color is enhanced.

Furthermore, in this embodiment, all of the processes in the operation illustrated in FIG. 2 are performed by the MFP 10. However, part of the processes in the operation illustrated in FIG. 2 could be performed by a computer other than the MFP 10 such as by a PC (Personal Computer).

With this configuration, the image-forming device that executes the color-conversion program of this disclosure generates an output image by converting the color of an input image so that when the centroid of a cluster, which is a collection of approximate colors in an input image is included in a specific range in color space, that centroid is moved to a representative color in that range. Therefore, it is possible to convert the color of an input image and generate an output image in which the color in a specific range has been enhanced.

With this configuration, the color-conversion method of this disclosure generates an output image by converting the color of an input image so that when the centroid of a cluster, which is a collection of approximate colors in an input image is included in a specific range in color space, that centroid is moved to a representative color in that range. Therefore, it is possible to convert the color of an input image and generate an output image in which the color in a specific range has been enhanced.

There are cases in which converting the color of an input image and generating an output image in which a specific color is enhanced is preferred.

Here, there is a color remembered by many people as being the ideal color of a specific target such as a plant leaf, the sky, human skin and the like, or in other words, there is a memory color. Therefore, when approximate colors of a memory color are included in an input image, there are cases in which converting the color of the input image and generating an output image in which the memory color is enhanced is preferred.

However, there are typical image-forming devices that move a color outside a color area to within the color area when converting the color of an input image and generating an output image, however, the device does not convert the color of an input image and generate an output image in which a specific color is enhanced.

The image-forming device, color-conversion program and color-conversion method of this disclosure are able to convert the color of an input image and generate an output image in which a specific color is enhanced.

The image-forming device of this disclosure is an MFP in this embodiment, however, an image-forming device other than an MFP, such as a printer only machine, is also possible.

What is claimed is:

1. An image-forming device comprising:
a Central Processing Unit (CPU); and
a storage device that stores a color-conversion program,
wherein the CPU, by executing the color-conversion program, functions as:
a centroid acquisition unit that acquires a centroid of a cluster, which is a collection of approximate colors in an input image;
a color-conversion-information generation unit that generates color-conversion information for converting the input image to an output image; and
an output-image generation unit that converts the color in the input image by using the color-conversion information that is generated by the color-conversion-information generation unit and generate the output image; and
wherein, in the case where the centroid that is acquired by the centroid acquisition unit is included in a specific range in color space, the color-conversion information is information for moving a color in the input image according to movement of the centroid when moving the centroid to a representative color in the specific range.

2. The image-forming device according to claim 1, wherein:
the centroid acquisition unit, when determining the cluster to which a color in the input image belongs, determines that when the difference of two target colors is less than a specific color difference, and the absolute value of the difference in the hue angles of the two target colors is equal to or less than a specific difference, the two target colors are approximate colors;
when the hue angles of the two target colors are included within a specific angle range, the specific difference is large when compared with when the hue angles of the two target colors are not included within the specific angle range; and
the specific angle range includes the hue angles of the specific range.

3. The image-forming device according to claim 1, wherein the specific range is a range of a specific memory color.

4. A non-transitory computer-readable recording medium that stores a color-conversion program, the color-conversion program causing a Central Processing Unit (CPU) of an image-forming device to function as:
a centroid acquisition unit that acquires a centroid of a cluster, which is a collection of approximate colors in an input image;
a color-conversion-information generation unit that generates color-conversion information for converting the input image to an output image; and
an output-image generation unit that converts the color in the input image by using the color-conversion information that is generated by the color-conversion-information generation unit and generate the output image,
wherein, in the case where the centroid that is acquired by the centroid acquisition unit is included in a specific range in color space, the color-conversion information is information for moving a color in the input image according to movement of the centroid when moving the centroid to a representative color in the specific range.

5. A color-conversion method performed by an image-forming device that comprises a Central Processing Unit (CPU) and a storage device storing a color-conversion program,
the method, by executing the color-conversion program by the CPU, comprising:
acquiring a centroid of a cluster, which is a collection of approximate colors in an input image;
generating color-conversion information for converting the input image to an output image; and
converting the color in the input image by using the color-conversion information that is generated and generates the output image,
wherein, in the case where the centroid that is acquired is included in a specific range in color space, the color-conversion information is information for moving a color in the input image according to movement of the centroid when moving the centroid to a representative color in the specific range.
